(19) United States
(12) Patent Application Publication
(10) Pub. No.: US 2010/0314447 A1
(43) Pub. Date: Dec. 16, 2010

(54) MEASUREMENT DEVICE WITH MOTION-TRIGGERED DATA EXCHANGE

(75) Inventor: Hans-Peter Zimmermann, Waldbronn (DE)

Correspondence Address: Agilent Technologies, Inc. in care of:;CPA Global, P. O. Box 52050, Minneapolis, MN, 55402, US

(73) Assignee: AGILENT TECHNOLOGIES, INC., Santa Clara, CA (US)

(21) Appl. No.: 12/738,835

(22) PCT Filed: Oct. 17, 2007
(86) PCT No.: PCT/EP07/61102

§ 371 Date: Sep. 2, 2010

(51) Int. Cl. G06K 7/01; G06K 7/04; G06K 7/08; G06K 7/14

(52) U.S. Cl. 235/462.1; 235/449; 235/462.13; 235/453; 235/439

(57) ABSTRACT

A measurement device (100) comprising an accommodation chamber (102) adapted for accommodating a replaceable measurement member (104), a movable closure mechanism (106) adapted to be moved to selectively expose or cover the accommodation chamber (102), and a data mechanism (600) adapted for at least one of reading data from and writing data on a replaceable measurement member (104), when the replaceable measurement member (104) is accommodated in the accommodation chamber (102), upon moving the movable closure mechanism (106).

### BACKGROUND ART

The present invention relates to measurement devices.

In microstructure technology applications, fluid may be conveyed through miniaturized channels (which may be filled with gel material). For a capillary electrophoresis device as an example for such a microstructure technology application, it may be necessary to generate an electric field in the fluid channels in order to allow for a transport of components of the fluid through the channels by electric forces. Such an electric force or field may conventionally be generated by dipping contact pins of the capillary electrophoresis device into the fluid which may be filled in a well defined by a carrier element coupled to a microfluidic chip, and by applying an electrical voltage to such contact pins.

US 2005/0011764 discloses that in a system for operation or handling of a laboratory microchip for chemical processing or analysis, the microchip is mounted in a first physical unit. The microchip is arranged on a mounting plate, such that it is readily accessible from the top and thus the fitting and removal of the microchip is considerably simplified. Furthermore, the first physical unit comprises an optical device for contactless detection of the results of the chemical processes conducted on the microchip. The supply systems necessary for the operation of the microchip are arranged in a module unit that has a separable connection with a second physical unit.

### DISCLOSURE

It is an object of the invention to provide a measurement system in which performed operations may be retraced. The object is solved by the independent claims. Further embodiments are shown by the dependent claims.

According to an exemplary embodiment, a measurement device (such as a biochemical analysis device applicable in the field of life science) is provided comprising an accommodation chamber (such as a receptacle for a microfluidic chip) adapted for accommodating a replaceable measurement member (such as a microfluidic chip), a movable closure mechanism (such as a tilting or sliding mechanism) adapted to be moved (for instance linearly or by pivoting) to selectively expose (for instance to enable external access to) or cover (for instance to disable external access to) the accommodation chamber, and a data mechanism (for instance a mechanism allowing for a unidirectional or bidirectional exchange of data) adapted for at least one of reading data from and writing data on a replaceable measurement member, when the replaceable measurement member is accommodated in the accommodation chamber, upon moving the movable closure mechanism.

According to another exemplary embodiment, a method of operating a measurement device is provided, the method comprising inserting a replaceable measurement member in an accommodation chamber, moving a movable closure mechanism to selectively expose or cover the accommodation chamber, and at least one of reading data from and writing data on a replaceable measurement member, when the replaceable measurement member is accommodated in the accommodation chamber, upon moving the movable closure mechanism.

According to still another exemplary embodiment, a software program or product is provided, preferably stored on a data carrier, for controlling or executing the method having the above mentioned features, when run on a data processing system, such as a computer.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in the context of controlling operation of measurement systems. The measurement system control scheme according to an embodiment of the invention can be performed or assisted by a computer program, i.e. by software, or by using one or more special electronic optimization circuits, i.e. in hardware, or in hybrid form, i.e. by means of software components and hardware components.

According to an exemplary embodiment, a measurement device is provided which has a movable mechanism to close an accommodation chamber having a measurement member mounted therein or thereon. The mechanism is configured so that automatically upon closing and/or opening, a data read and/or write procedure is activated to transfer data between the measurement device and the measurement member. In other words, an interaction between a data mechanism of the measurement device and a corresponding data source and/or data destination of the measurement member may be triggered when actuating the closure mechanism. Thus, the actuation of the closure mechanism (for instance by a muscle force of a user having previously loaded the measurement member in the accommodation chamber) may be functionally coupled to the read and/or write system so that a performed measurement to be started after closing the closure mechanism may be documented automatically on the basis of the read/written data. This may allow to later assign a specific measurement or parameters thereof to a specific measurement member. Such a documentation may be advantageous in the field of life science, for instance in the field of pharmacological analysis.

Particularly, a cartridge or supply unit (for instance to supply pressure, voltage, etc. for a biochemical analysis) may approach a microfluidic chip when closing the closure mechanism. During this approaching procedure which may result in a functional and/or mechanical contact between the supply unit and the microfluidic chip, the supply unit may read information from the microfluidic chip, or may write information into the microfluidic chip. For instance using an RFID or a barcode read/write mechanism, a horizontally sliding or vertically pivoting supply unit may automatically read the barcode or write data in the RFID tag during the opening or closure procedure.

Next, further exemplary embodiments of the measurement device will be explained. However, these embodiments also apply to the method and the software program or product.

The accommodation chamber may comprise a microfluidic chip receptacle adapted for receiving a microfluidic chip. In other words, the accommodation chamber may be specifically designed, shaped or dimensioned to receive a microfluidic chip which may be a substrate having fluidic channels or the like formed in a surface thereof. Using such a microfluidic chip, gel electrophoresis experiments and/or liquid chromatography experiments may be carried out. Such a microfluidic chip may be mounted on and/or in the accommodation chamber to be located at a fixed position of the measurement device.

The measurement member may be accommodated in the accommodation chamber. In order to allow to employ the measurement device in combination with different measurement members, the measurement members may be substituted or replaced in accordance with a specific analysis to be carried out with the measurement device. Thus, the measurement device may be capable for use in various applications, wherein each microfluidic chip of a set to be inserted into the accommodation chamber may be assigned to a specific use of the measurement device.

The measurement member may comprise a data carrier carrying (particularly storing or encoding) the data readable by the data read mechanism. Such a data carrier may be any entity which comprises data which can be read from the data carrier. Such data may be permanently stored information such as a printed barcode. Such data may be alterable information such as data stored in an electronic memory such as an EEPROM. For example, a microfluidic chip may comprise a barcode which includes an unambiguous or unique identification of the respective microfluidic chip.

The measurement member may also comprise a data carrier which is adapted to store the data writable by the data mechanism. For example, such a data carrier in which information can be written may be an RFID tag (Radio Frequency Identification Tag). In a wireless manner, via an inductive coupling with a corresponding RFID read/write device, such information may be transmitted from the read/write device to the data carrier, or vice versa.

The movable closure mechanism may be adapted to be shifted linearly (i.e. along a straight direction) to selectively expose or cover the accommodation chamber. Such a configuration may be realized by providing the movable closure mechanism as a drawer mechanism, particularly as a push loading drawer mechanism. Particularly, with a single pushing or pulling operation in one direction or in another direction opposite to the one direction, a user may manually actuate the movable closure mechanism to selectively open or close the measurement apparatus. Automatically correlated with such an opening or closing motion, the read and/or write operation may be performed. With such a sliding mechanism, it is easily possible to force an electromagnetic radiation beam (for instance a laser beam) generated by a barcode reader to be scanned over a barcode provided on the measurement member. Thus, by a common sliding motion, the measurement apparatus may be selectively opened or closed and simultaneously the barcode scanning may be performed.

The movable closure mechanism may also be adapted to be pivoted or tilted to selectively expose or cover the accommodation chamber. In such a context, the movable closure mechanism may be adapted as a tilting mechanism. In such a mechanism, a lid of the measurement device may be pivoted for instance around a horizontal axis so that the pivoting lid may selectively cover the measurement member (by a downward motion) or may expose the accommodation chamber (by an upward motion). Such a mechanism may be particularly advantageous when the data read/write mechanism shall be triggered in dependence of a distance between the data carrier and the read/write mechanism. For example, in the case of an RFID tag, a read/write device is capable of reading/writing information from or to an RFID tag only when a distance between the reader and the RFID tag is smaller than an adjustable threshold value. Thus, when the distance is large (the tilting mechanism is open and the lid is far away from the surface of the measurement member), no reading or writing is enabled. However, upon closing the movable closure mechanism by operating the tilting mechanism, the lid approaches the measurement member, thereby reducing a distance between the read/write unit and the RFID tag. Thus, upon closing, a read or write operation may be triggered automatically.

The data mechanism may be adapted for reading and/or writing the data upon closing the movable closure mechanism to cover the accommodation chamber.

Thus, the closing actuation may be the trigger for activating the read or write operation. Therefore, immediately before performing an analysis with the measurement device, the corresponding reading operation may be performed. Particularly, a specific measurement sequence may be unambiguously assigned to a specific measurement member so that reading out identifying information characterizing the measurement member may be used to select one of a number of possible measurement sequences to be subsequently performed.

Additionally or alternatively, the data mechanism may be adapted for reading and/or writing the data upon opening the movable closure mechanism to expose the accommodation chamber. For instance, when previously data have been read or written upon a closure motion, it may happen that these data are lost (for instance in case of an electrical power outage). When repeating the reading or writing operation upon opening the closure mechanism (for instance after an analysis), even in the case of the loss of such data, the presence of a complete set of data may be ensured.

The data mechanism may be adapted for reading and/or writing data identifying a replaceable measurement member accommodated in the accommodation chamber. Therefore, unique identification information regarding the replaceable measurement member (such as a product charge number) may be derived. This may prevent any manipulation of measurement data and may allow to document properly which experiment has been carried out at which time with which measurement member.

However, the data mechanism may also be adapted for reading and/or writing other data, for example data identifying a product type of the replaceable measurement member accommodated in the accommodation chamber. An identity of a product may include a type of a microfluidic chip, such as a serial number of a chip, or the information whether the chip is a DNA chip, a cholesterol chip, etc. When reading a product type of the measurement member, a subsequent analysis may be performed in accordance with specific requirements of a specific product. For example, if a specific microfluidic chip requires a specific sequence of instructions or control parameters, these may be adjusted automatically by the measurement device after having read the product type of the measurement member which has been inserted by a user in the measurement device. This may prevent a time-consuming manual indication of the product type of the measurement member by a user, but can be carried out automatically by exemplary embodiments.

The data mechanism may be adapted for writing data representative for a history of the replaceable measurement member. For example, the entire measurement history of the measurement member may be documented in a measurement member data carrier. For example, it may happen that the measurement member may be used only a specific number of times, for instance for five analysis procedures. The number of remaining analysis procedures may then be stored in the measurement member. The history stored in a data carrier may be indicative of the use of the chip in the past, for instance information regarding sample preparation, purification, the performance of PCR operations, etc. may be included.

A supply member may be provided in the measurement device which may be adapted for providing the measurement with measurement equipment. Such measurement equipment may comprise a voltage supply for supplying a voltage to components of the measurement device, an electric field generator adapted for supplying electric field generating signals, a magnetic field generator adapted for generating a magnetic field if desired, a valve for pressure control, a temperature controller, etc. In other words, the supply member may provide the measurement device, in the context of a life science apparatus, with any physical equipment required for carrying out the actual analysis.

Such a supply member which may be a replaceable cartridge may be insertable in a substitutable manner in a recess of the movable closure mechanism. By such a modular system, it may be possible for a user to insert a specific supply member or cartridge into the measurement device, in accordance with user-defined preferences or a specific analysis to be carried out. For example, in the context of such a modular system, relatively simple cartridges may be offered, and more complex cartridges offering additional functionalities such as a barcode reader scanning of a barcode on a measurement member may be provided.

The supply member may be mountable on the movable closure mechanism to be configured for being moved together with the movable closure mechanism. In other words, when the supply member is mounted on the movable closure mechanism, a motion of the movable closure mechanism may be followed by a corresponding motion of the supply member.

The measurement device may comprise a lid being configured for being moved with the movable closure mechanism and relative to a base member of the measurement device. Such a lid may comprise a recess shaped and dimensioned for receiving a corresponding cartridge.

The supply member may comprise a cartridge having electric pins for supplying an electric signal to the measurement member, particularly to a microfluidic chip of the measurement member. For example, it may be possible that a gel electrophoresis analysis shall be performed in channels of a microfluidic chip. For this purpose, it may be required to provide a fluidic sample in the channels with electric signals to generate an electric field as a basis for electrophoresis. This may be provided by the cartridge having electric pins which can be supplied with electric signals and which may dip or immerse into channels of the microfluidic chip. Upon closing the movable closure mechanism, the electric pins may automatically dip into the channels of the measurement member, and simultaneously the read and/or write mechanism may be activated.

The movable closure mechanism may be adapted to functionally couple the electric pins of the cartridge with the measurement member in an operation state in which the movable closure mechanism covers the accommodation chamber. Thus, the closure actuation may go hand in hand with the read/write activation and with the functional coupling between the electric pins and the measurement member. Therefore, a plurality of procedures may be coupled to be performed at the same time which allows for a time-efficient operation of the measurement device.

The data mechanism may comprise an optical scanner. An optical scanner may be a device which allows to scan a surface having portions with different optical properties, thereby allowing to measure a “fingerprint” pattern of a surface in which information to be read may be encoded. For example, a (for instance one-dimensional or two-dimensional) barcode may be provided which may be a sequence of bars or strips having varying thickness and/or varying color. In this sequence, information may be encoded.

It is also possible that a data mechanism is formed by an RFID tag reader which is capable of reading information from or writing information on an RFID tag having an integrated circuit in a wireless manner. RFID tag reader and RFID tag may communicate inductively via coils. The RFID tag reader may also provide energy for operating the RFID tag.

A mechanical code detector may also be provided, for instance a detector which is capable of sampling or scanning a spatially dependent topography of a surface in which information is encoded. It is also possible that the data mechanism involves an alphanumerical code detector which reads numbers and/or letters on a surface (for instance printed or engraved). A magnetic stripe scanner may be implemented which is capable of reading a spatially dependent magnetic field formed by a pattern of magnetic and non-magnetic portions on a surface.

Correspondingly to the above configurations of the data mechanism, the measurement member may comprise an optically scannable code, an optically reflective code, a fluorescence code, a barcode, an RFID tag, a mechanical code, an alphanumerical code, a magnetic stripe, respectively. In other words, the encoding of the measurement member may be in accordance with the above-mentioned embodiments for the data mechanism.

The data mechanism may be adapted for passing over at least a part of the replaceable measurement member upon moving the movable closure mechanism. Such a motion may simultaneously close the accommodation chamber and allow the data mechanism to scan a surface of the measurement member for read and/or write purposes.

According to an exemplary embodiment, the data mechanism may comprise an electromagnetic radiation source (such as a light source) for emitting an electromagnetic radiation beam (such as an essentially two-dimensional planar light beam) towards the replaceable measurement member (for instance forming a straight light line on a surface of the measurement member), and may comprise an electromagnetic radiation detector (such as a photodiode or an array of photodiodes) for detecting the electromagnetic radiation beam after interaction with the replaceable measurement member upon moving the movable closure mechanism. In other words, a light beam may impinge on a surface of the measurement member and may scan a portion of the measurement member. Upon reflection of the light, this light may be directed towards a light detector which is then capable of deriving the information encoded in the data carrier such as a barcode on the surface.

Particularly, the data mechanism may comprise a reflective or deflective element (such as a reflective mirror) for reflecting the electromagnetic radiation beam between the electromagnetic radiation source and the electromagnetic radiation detector on the one hand and the replaceable measurement member on the other hand.

The measurement device may comprise a documentation unit adapted for documenting data read and/or written by the data mechanism. Such a documentation unit may comprise a memory or a storage unit in which the read data may be stored. Thus, at a later time, for each of the analysis performed by the measurement device, the corresponding set of information or data may be read from the documentation unit allowing to retrace what happened during this experiment. In this documentation, also information read from the measurement member may be included.

According to an exemplary embodiment, an RFID tag or barcode on a microfluidic chip may be provided, wherein upon closing a measurement device (such as a 2100 Bioanalyzer of Agilent Technologies), a readout operation of the RFID tag or barcode may be initiated (for instance for identifying the microfluidic chip used for a present analysis). Thus, a closure mechanism may be used as a trigger for reading out data. This allows to detect each user operation during an analysis.

The measurement device may be a microfluidic device allowing for a measurement of a fluid with dimensions of the components in the order of magnitude of micrometers or less and/or with volumes in the order of magnitude of microlitres or less. According to an exemplary embodiment, a measurement device with an insertable cartridge may be provided, wherein a closing or opening motion automatically initiates the performance of a scanning operation resulting in a read out of information on the cartridge.

The measurement apparatus may be a fluid separation apparatus which may comprise a separation control unit adapted for controlling separation of compounds of the fluid. Such a control unit may control the voltages applied to the fluid, the supply of fluids, a separation scheme or sequence, or the like.

The fluid separation device may be a gel electrophoresis device or a liquid chromatography device, for instance an HPLC (High Performance Liquid Chromatography).

The microfluidic chip of the fluid separation apparatus may have microchannels into which a fluid and/or a gel may be introduced. “Microfluidics” may particularly be denoted as the science of designing, manufacturing, and forming devices and processes with volumes of liquid in the order of microlitres, nanolitres or picolitres. Such devices themselves may particularly have dimensions ranging from centimeters, millimeters down to micrometers.

The measurement device may be adapted to analyze at least one of the group consisting of a physical, a chemical and a biological parameter of at least one component of the fluid. Examples for physical parameters are temperature, pressure, volume, or the like. Examples for chemical parameters are a concentration of a component, a pH value of a liquid, or the like. Examples for biological parameters are the presence or absence of proteins or genes in a solution, the biological activity of a sample, or the like.

The measurement device may comprise at least one of a sensor device, a device for chemical, biological and/or pharmaceutical analysis, a capillary electrophoresis device, a liquid chromatography device, a gas chromatography device, an electronic measurement device, and a mass spectroscopy device. Exemplary application fields are gas chromatography, mass spectroscopy, UV spectroscopy, optical spectroscopy, IR spectroscopy, liquid chromatography, and capillary electrophoresis (bio-)analysis. The measurement device may be integrated in an analysis device for chemical, biological and/or pharmaceutical analysis. When the measurement device is a device for chemical, biological and/or pharmaceutical analysis, functions like (protein) purification, electrophoresis investigation of solutions, fluid separation, or chromatography investigations may be performed with such an analysis device.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a measurement device according to an exemplary embodiment in an opened operation mode.

FIG. 2 illustrates a replaceable cartridge insertable in the measurement device of FIG. 1.

FIG. 3 shows another view of the replaceable cartridge of FIG. 2.

FIG. 4 shows a further view of the replaceable cartridge of FIG. 2.

FIG. 5 shows the measurement device of FIG. 1 in a closed operation mode.

FIG. 6 shows the measurement device of FIG. 1 in an operation mode in which the replaceable cartridge is only partially inserted into the measurement device.

FIG. 7 shows an interior of the cartridge of FIG. 3 and FIG. 4.

FIG. 8 shows a measurement device according to another exemplary embodiment.

The illustration in the drawing is schematically.

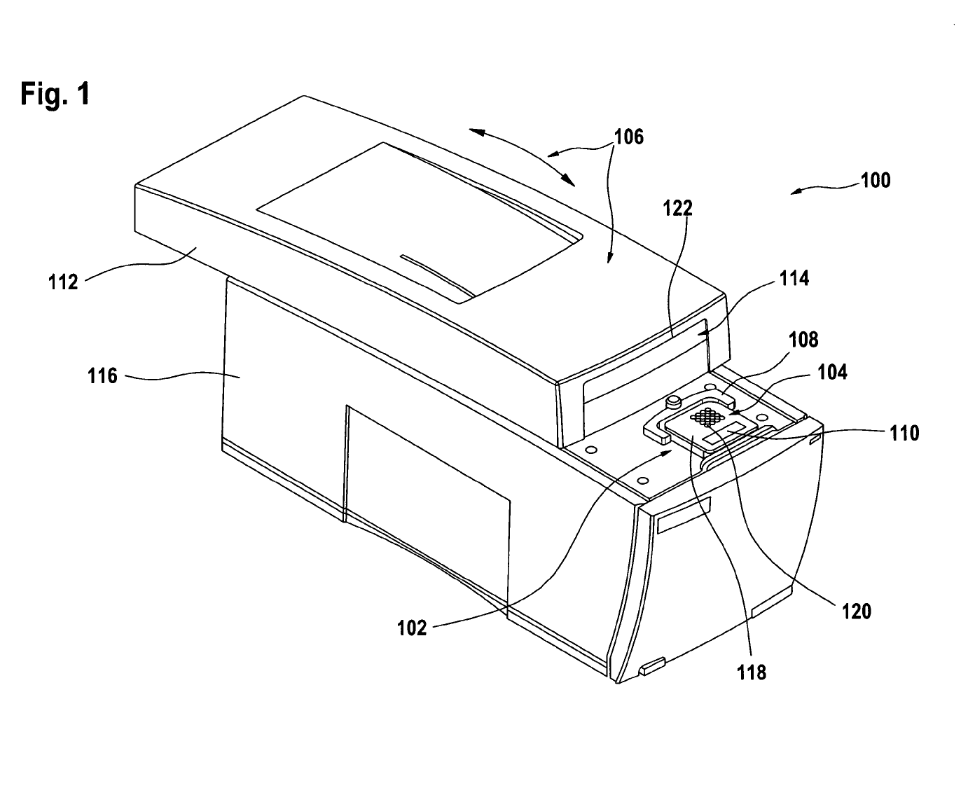

In the following, referring to FIG. 1, a measurement device 100 adapted for carrying out a life science experiment, more particularly a gel electrophoresis experiment, according to an exemplary embodiment will be explained.

The measurement device 100 comprises a casing 116 enclosing components of a base part of the measurement device 100. The casing 116 comprises a plurality of electric components forming a lower portion of the device 100. Apart from this, an upper portion of the measurement device 100 is provided which is movable with respect to the lower portion, and which is covered by a lid 112.

An accommodation chamber 102 is provided on an upper surface of the casing 116 and is adapted for accommodating a replaceable microfluidic chip 104 to be inserted and fastened by a user in the accommodation chamber 102.

The microfluidic chip 104 comprises a glass or plastic substrate 118 on the surface on which a plurality of wells 120 are formed. Before starting an analysis with the measurement device 100, a pipette may be used to fill in a fluidic sample in at least a part of the wells 120. In accordance with specific requirements of an analysis, a user may select one of a set of a plurality of different microfluidic chips and may insert such a microfluidic chip 104 into a fastening member 108. As can be taken from FIG. 1, a barcode 110 (i.e. a number of alternating black and white bars having different thicknesses and/or distances from one another) is formed on a surface of the substrate 118 of the microfluidic chip 104.

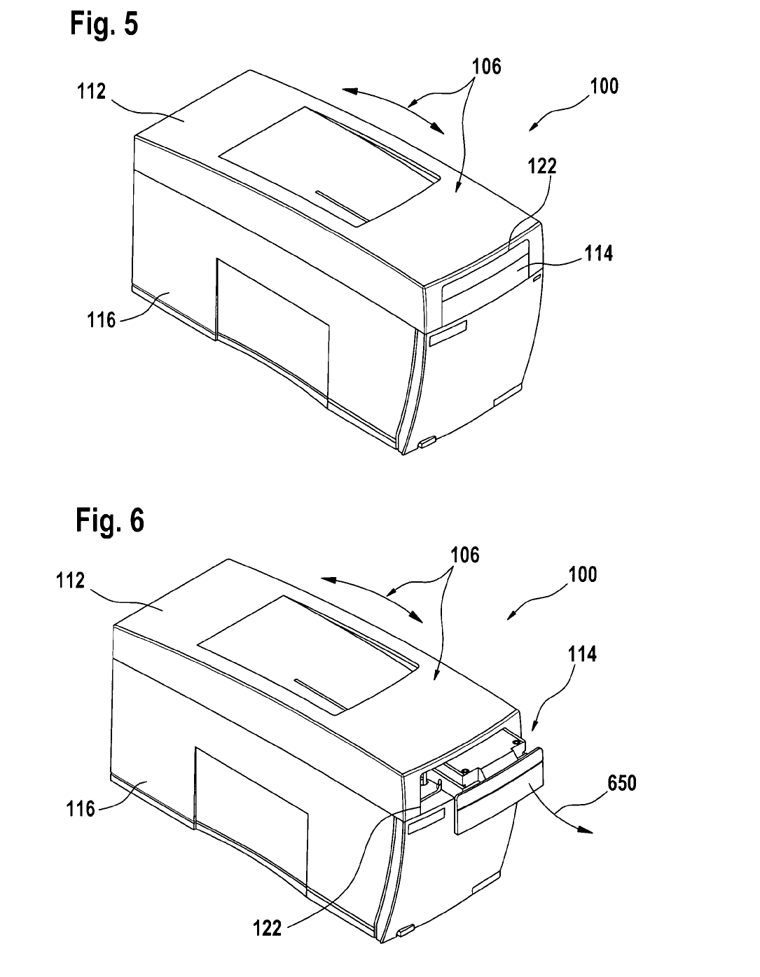

As indicated with reference numeral 106, a movable closure mechanism is provided which is adapted to be moved to selectively expose the accommodation chamber 102 with regard to an environment (as shown in the operation mode of FIG. 1) or to selectively cover the accommodation chamber 102 against the environment (as shown in the operation mode of FIG. 5). A user may operate the movable closure mechanism 106 by manually sliding the lid 112 along a direction indicated by an arrow 106 with respect to the base part or casing 116.

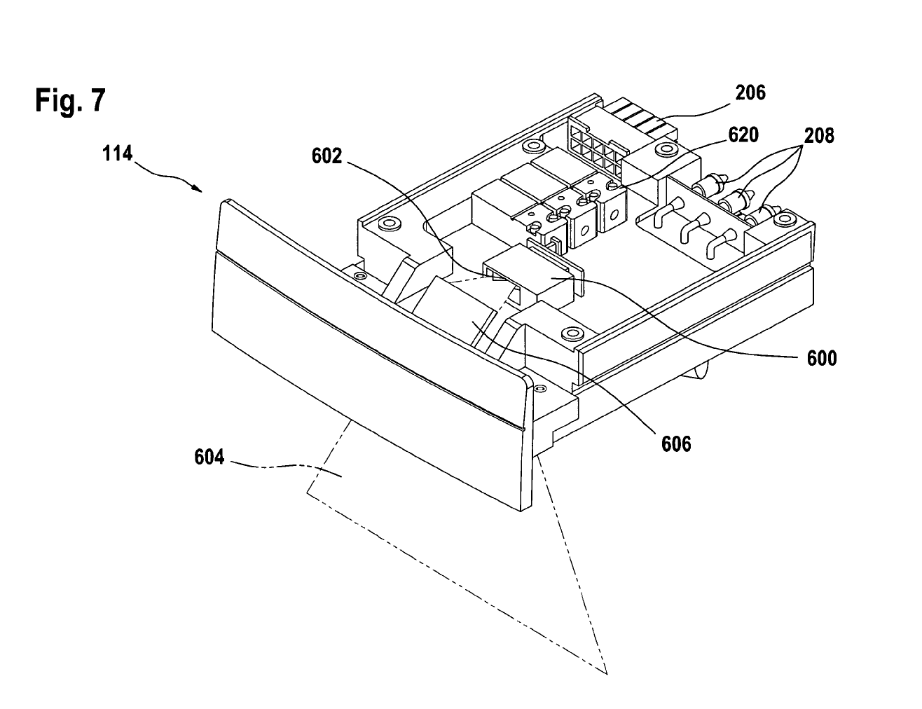

As shown in further detail in FIGS. 7, a data read mechanism 600 is provided for reading data from the barcode 110 on the replaceable measurement member 104 when the replaceable measurement member 104 is accommodated in the accommodation chamber 102 upon moving the movable closure mechanism 106 towards a closed operation mode of the measurement device 100. In other words, when the lid 112 is manually operated by a user to close the apparatus or to cover the measurement member 104, a barcode reader (not shown in FIG. 1) scans the barcode 110 on the surface of the microfluidic chip 104 to read information therefrom. Thus, the closure motion is functionally coupled with the data readout mechanism.

The movable closure mechanism 106 is adapted to be shifted linearly to selectively expose or cover the accommodation chamber 102. Thus, the movable closure mechanism 106 is a drawer mechanism, which may also be denoted as a push loading drawer mechanism. By sliding the lid 112 with respect to the casing 116, the microfluidic chip 104 is covered to subsequently start an electrophoresis experiment for analyzing a sample filled into the wells 120 of the microfluidic chip 104.

Upon closing the movable closure mechanism 106, the data mechanism 600 automatically reads data from the barcode 110. The barcode 110 may encode information allowing to identify a specific microfluidic chip 104 accommodated in the accommodation chamber 102. A memory (not shown) may be provided in the measurement apparatus 100 which allows to store this information for later access or evaluation.

The substitutable supply member 114 accommodated in a correspondingly formed recess 122 in the lid 112 (as can be seen best in FIG. 6) allows for providing the measurement device 100 with measurement equipment. When the cartridge 114 is received in the recess 122, it moves together with the movable closure mechanism 106. The cartridge 114 is detachably inserted into the lid 112, in accordance with user preferences. For instance, a set of cartridges 114 may be provided, and the user may select a specific one which is appropriate for the present measurement conditions. This corresponding cartridge may then be mounted in the recess 122. In the present embodiment, a cartridge 114 is inserted in the recess 122 which cartridge 114 comprises a barcode reading functionality. When the movable closure mechanism 106 is operated and the lid 112 is moved to cover the microfluidic chip 104, the barcode reading mechanism 600 passes the replaceable microfluidic chip 104 and therefore scans the barcode 110 to read information therefrom. Therefore, FIG. 1 shows the analyzer 100 in an operation mode in which the lid 112 does not cover the microfluidic chip 104. However, upon closure of the measurement device 100, the barcode 110 of the chip 104 is scanned.

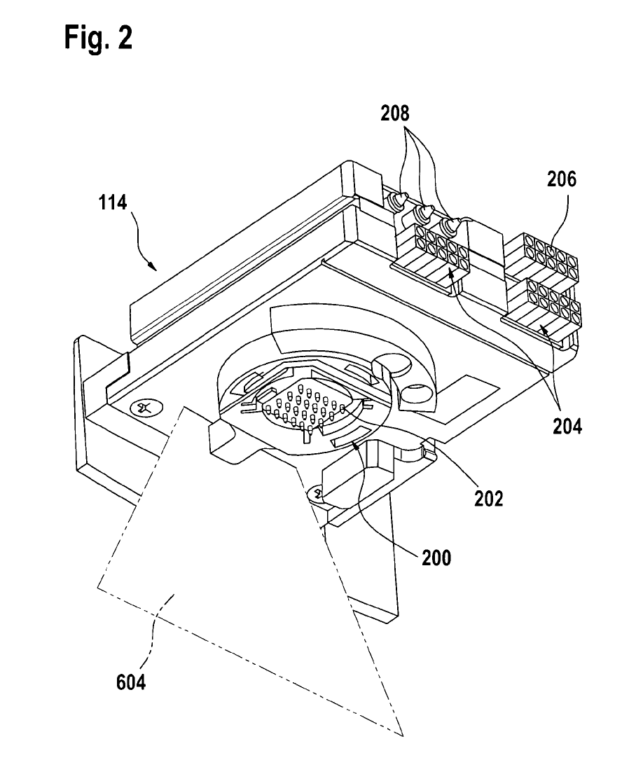

In the following, the cartridge 114 will be explained in more detail referring to FIG. 2.

The cartridge or cassette 114 includes the barcode reader, which will be explained in more detail referring to FIG. 7. However, FIG. 2 shows connection plugs 204 which are configured as HV (high voltage) connectors to provide a high voltage. This high voltage may be applied to electrically conductive pins 202 which may be provided on a substitutable measurement plate 200 of the cartridge 114. Beyond this, a connector 206 is provided to supply signals for the barcode scanner, valves, etc. Furthermore, pressure connectors 208 are shown as well interfacing the cartridge 114 with pressure sources/pressure destinations.

The cartridge 114 comprises the number of electric pins 202 arranged in a matrix-like manner and adapted for supplying an electric signal to the measurement member 104, particularly to the wells 120 in the microfluidic chip 104. For performing a gel electrophoresis experiment, it may be required to provide electric signals to the sample in the wells 120 for generating electric fields. This may be performed by the electric pins 202. The movable closure mechanism 106 may be arranged to functionally couple the electric pins 202 of the cartridge 114 with the measurement member 104 in an operation state in which the movable closure mechanism 106 covers the accommodation chamber 102. Thus, upon closing the lid 112, the electric pins 202 will dip into the wells 120 simultaneously with the closing of the apparatus 100 and simultaneously with the reading of the barcode 110.

A scanner beam 604 is shown as well in FIG. 2 and will be explained in more detail referring to FIG. 7.

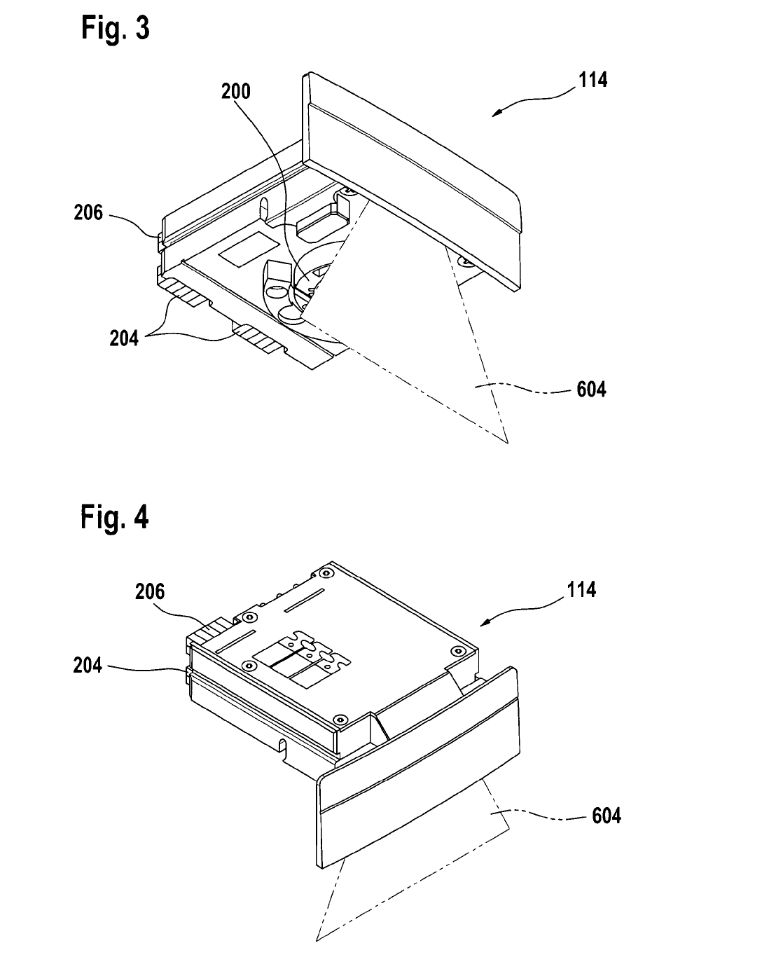

FIG. 3 and FIG. 4 show further views of the cartridge 114.

FIG. 5 and FIG. 6 show further views of the measurement device 100.

In FIG. 5, the analyzer 100 is closed, i.e. the accommodation chamber 102 is enclosed by the lid 112 and the casing 116. In this operation mode, an analysis of a sample may be carried out.

In FIG. 6, the cassette 114 with the barcode reader 600 is partially removed from the recess 122 and can be detached from the measurement device 100 by a forward motion indicated with reference numeral 650.

In the following, referring to FIG. 7, the cartridge 114 will be described in more detail in an operation mode in which a cover has been removed therefrom. Therefore, several components of the cartridge 114 are exposed in FIG. 7.

FIG. 7 therefore shows valves 620 for the pressure system of the cartridge 114. A scan engine 600 which may form part of a barcode reader is shown as well and can be realized by the product Symbol SE950. A mirror 606 for reflecting an electromagnetic radiation beam 604 is shown as well. Furthermore, a light source is indicated with reference numeral 602.

Therefore, the barcode reader mechanism further comprises the light source 602 emitting the light beam 604 which, via the mirror 606, is deflected towards the replaceable measurement member 104 (not shown in FIG. 7). The barcode reader mechanism further comprises an electromagnetic radiation detector (included in the member 600) for detecting the light beam 604 after reflection by the surface of the microfluidic chip 104 upon moving the movable closure mechanism 106. Thus, the reflected beam 604 can be evaluated within the member 600 to derive the information encoded in the barcode 110.

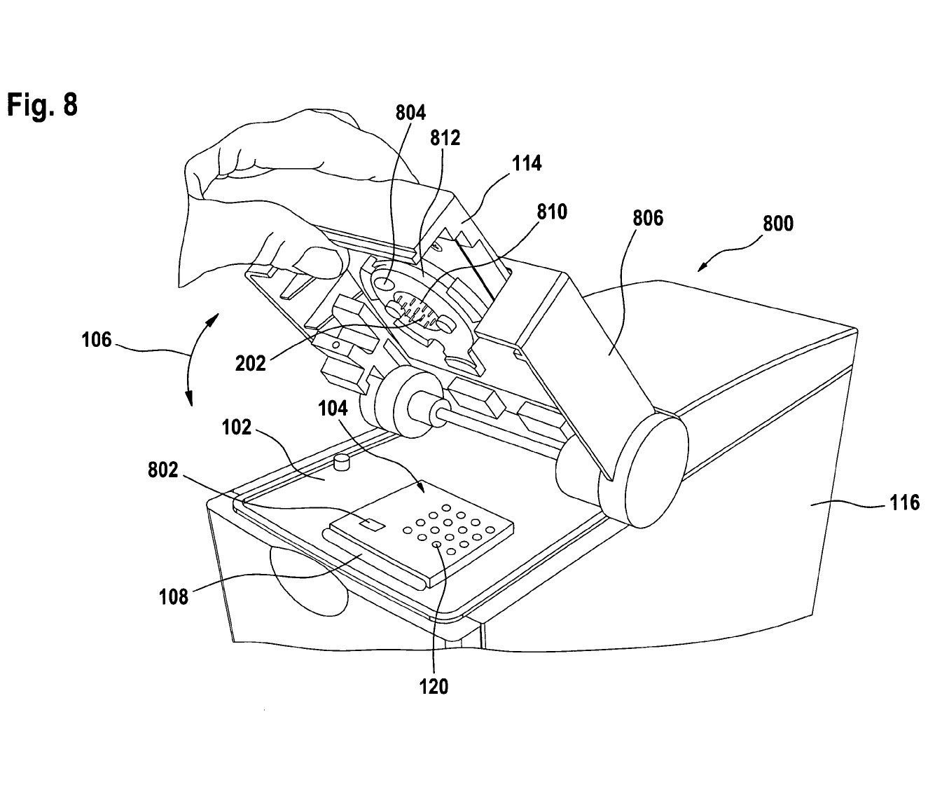

In the following, referring to FIG. 8, a measurement apparatus 800 according to another exemplary embodiment will be explained.

The embodiment of FIG. 8 is based on an RFID read/write mechanism, as will be explained in the following.

An intermediate carrier 810 is mounted in a substitutable manner on the cartridge 114 and may be connected to the cartridge 114 via a bayonet mechanism 812.

An RF ID read/write unit 804 is embedded in the cartridge 114. An RF ID tag 802 is provided on the microfluidic chip 104. The closure mechanism 106 is a tilting mechanism in FIG. 8, so that by tilting the cover 806 with respect to the base 116, the accommodation chamber 102 is covered by the lid 806 (see reference numeral 106). During the closure operation, the RFID reader 804 approaches the RFID tag 802, i.e. the distance between the RFID reader 804 and the RFID tag 802 becomes smaller. When the distance between the components 802, 804 falls below a threshold value, a data read and/or write communication between the components 804, 802 is enabled, thereby allowing to read or write data from or into the RFID chip 802 upon closing the apparatus 800. Namely, a communication between the RFID reader 804 and the RFID tag 802 is only possible when the distance between the RFID reader 804 and the RFID tag 802 is sufficiently small, due to a limited communication range defined by an amplitude of an electromagnetic field which may be generated by the RFID reader 804.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A measurement device, comprising
an accommodation chamber adapted for accommodating a replaceable measurement member,
a movable closure mechanism adapted to be moved to selectively expose or cover the accommodation chamber and
a data mechanism adapted to perform an operation of at least one of: reading data from and writing data on a replaceable measurement member, when the replaceable measurement member is accommodated in the accommodation chamber upon moving the movable closure mechanism, wherein the data mechanism is configured to perform the operation automatically correlated with the movement of the movable closure mechanism.

2. The measurement device of claim 1, comprising at least one of:
the movable closure mechanism is adapted to be shifted linearly to selectively expose or cover the accommodation chamber;
the movable closure mechanism is adapted to be pivoted to selectively expose or cover the accommodation chamber;
the movable closure mechanism is a drawer mechanism, particularly a push loading drawer mechanism;
the movable closure mechanism is a slider mechanism;
the movable closure mechanism is a tilting mechanism.

3. The measurement device of claim 1, comprising at least one of:
the data mechanism is adapted for reading and/or writing the data upon at least one of: closing the movable closure mechanism to cover the accommodation chamber, and opening the movable closure mechanism to expose the accommodation chamber;
the data mechanism is adapted for reading and/or writing data identifying at least one of a replaceable measurement member and a product type of the replaceable measurement member accommodated in the accommodation chamber.

4. The measurement device of claim 1, wherein the data mechanism comprises at least one of:
at least one of the group consisting of an optical scanner, a barcode reader, a one-dimensional barcode reader, a two-dimensional barcode reader, an RFID tag reader, a mechanical code detector, an alphanumerical code detector, and a magnetic stripe scanner;
a barcode scanner adapted for reading a barcode provided on the replaceable measurement member only upon moving the movable closure mechanism in a manner that an electromagnetic radiation beam emitted by the barcode scanner passes the barcode on the measurement member and is transmitted to the barcode scanner for detection;
an RFID read and/or write unit adapted for reading information from and/or writing information in an RFID tag provided on the replaceable measurement member only upon moving the movable closure mechanism in a manner that only upon moving the movable closure mechanism a distance between the RFID read and/or write unit and the RFID tag becomes sufficiently small for a data read and/or write operation.

5. The measurement device of claim 1, comprising at least one of:
the measurement member comprises at least one of the group consisting of: an optically scannable code, an optically reflective code, a fluorescence code, a barcode, a one-dimensional barcode, a two-dimensional barcode, an RFID tag, a mechanical code, an alphanumerical code, and a magnetic stripe;
the data mechanism is adapted for passing at least a part of the replaceable measurement member upon moving the movable closure mechanism;
the measurement device comprises a documentation unit adapted for documenting data read and/or written by the data mechanism.

6. The measurement device of claim 1, comprising
a supply member adapted for providing the measurement device with measurement equipment.

7. The measurement device of claim 6, comprising at least one of:
the supply member is configured for being moved with the movable closure mechanism;
the measurement device comprises a lid configured for being moved with the movable closure mechanism, wherein the supply member is configured to be detachably insertable into the lid;
the measurement equipment of the supply member comprises at least one of the group consisting of a voltage supply, an electric field generator, a magnetic field generator, at least one valve for pressure control, and a temperature controller;
the supply member comprises a cartridge having electric pins for supplying an electric signal to the measurement member, particularly to a microfluidic chip of the measurement member.

8. The measurement device of claim 1,
wherein the data mechanism comprises an electromagnetic radiation source for emitting an electromagnetic radiation beam towards the replaceable measurement member and comprises an electromagnetic radiation detector for detecting the electromagnetic radiation beam after interaction with the replaceable measurement member upon moving the movable closure mechanism.

9. The measurement device of claim 8,
wherein the data mechanism comprises a deflective element for deflecting the electromagnetic radiation beam between the electromagnetic radiation source and the electromagnetic radiation detector on the one hand and the replaceable measurement member on the other hand.

10. The measurement device of claim 1,
being adapted as a fluid separation device for separating compounds of a fluid.

11. The measurement device of claim 10, wherein the fluid separation apparatus comprises at least one of:
a separation control unit adapted for controlling separation of compounds of the fluid;
the fluid separation apparatus comprises at least one of a sensor device, a device for chemical, biological and/or pharmaceutical analysis, a capillary electrophoresis device, a liquid chromatography device, a gas chromatography device, an electronic measurement device, and a mass spectroscopy device.

12. The measurement device of claim 10, comprising at least one of:
the fluid separation apparatus is adapted to analyze at least one of the group consisting of a physical, a chemical and a biological parameter of at least one compound of the fluid;
the accommodation chamber comprises a microfluidic chip receptacle adapted for receiving a microfluidic chip.

13. A method of operating a measurement device, the method comprising
inserting a replaceable measurement member in an accommodation chamber
moving a movable closure mechanism to selectively expose or cover the accommodation chamber, and
performing—automatically correlated with the movement of the movable closure mechanism an—operation of at least one of: reading data from and writing data on a replaceable measurement member.

14. A software program or product, stored on a non-transitory data carrier, for controlling or executing the method of claim 13, when run on a data processing system.
